(19) United States
(12) Patent Application Publication
(10) Pub. No.: US 2007/0273204 A1
(43) Pub. Date: Nov. 29, 2007

(54) Vehicle and control method of vehicle

(76) Inventors: Shinya Kodama, Susono-shi (JP); Michihito Shimada, Mishima-shi (JP); Kazuya Maki, Nagoya-shi (JP)

Correspondence Address: KENYON & KENYON LLP, 1500 K STREET N.W., SUITE 700, WASHINGTON, DC, 20005, US

(21) Appl. No.: 11/798,116

(22) Filed: May 10, 2007

(30) Foreign Application Priority Data
May 11, 2006 (JP) 2006-132863

(51) Int. Cl. B60T 8/64; B60T 8/60

(52) U.S. Cl. 303/146; 303/151

(57) ABSTRACT

In response to the driver's depression of a brake pedal, the hybrid vehicle of the invention utilizes both a master cylinder pressure Pmc and a pressure increase by two pumps included in two different braking systems of a brake actuator in an HBS to satisfy a braking force demand BF* required by the driver. In this case, the braking control of the invention corrects a basic pump command value dpB for the respective pumps with a pump command correction value dc (step S190), which is set according to a detected behavior of the hybrid vehicle in a braking state, and controls the brake actuator in the HBS to satisfy the braking force demand BF* (steps S170 to S200).

### BACKGROUND OF THE INVENTION

1. Field of the Invention

The present invention relates to a vehicle and a control method of the vehicle. More specifically the invention pertains to a vehicle equipped with a fluid pressure braking system for generating a braking force, as well as to a corresponding control method of such a vehicle.

2. Description of the Prior Art

In a prior art braking device for a vehicle, the proposed technique sets a front distribution and a rear distribution of a target braking force to make an ordinary gain of an actual yaw rate approach to an ordinary gain of a target yaw rate, while setting a left distribution and a right distribution of the target braking force to make the actual yaw rate approach to the target yaw rate. The braking force output from a wheel cylinder in each of left and right front and rear wheels is then regulated according to the settings of the front and rear distributions and the left and right distributions of the target braking force (see, for example, Japanese Patent Laid-Open Gazette No. H06-127354). This prior art braking device sets the front distribution and the rear distribution of the target braking force to uniformly compensate the ordinary yaw rate of the vehicle in a turning braking state. This widens the control range of the yaw rate characteristic induced by a transient difference in braking force between the left wheels and the right wheels, while reducing an ordinary input of difference in braking force between the left wheels and the right wheels to stabilize a varying deceleration. There is a known braking device of regenerative cooperative control system that is applicable to hybrid vehicles. In the braking device of regenerative cooperative control system, a fluid pressure produced by a fluid pressure generation system including an accumulator and an electric pump is regulated to be output by a pressure regulator according to a braking operational force. A master cylinder is actuated with a supply of fluid pressure to an auxiliary fluid pressure chamber. An output fluid pressure of the master cylinder and the pressure regulator is supplied to each wheel cylinder to apply a braking force to a corresponding wheel of the vehicle (see, for example, Japanese Patent Laid-Open Gazette No. 2004-182035).

### SUMMARY OF THE INVENTION

The front-wheel-drive vehicle generally uses a braking device equipped with a brake actuator of a cross arrangement. In this braking device, the brake actuator of the cross arrangement has two hydraulic systems that respectively include pumps to individually apply the braking force to a pair of left and right front wheels or to a pair of left and right rear wheels. There is a variation in pressure increase (especially a delayed response immediately after a start of pressure increase) between the multiple pumps, due to the individual variability or the surrounding temperature. The use of the multiple pumps may thus cause a difference in braking force between the two hydraulic systems, that is, between the pair of left and right wheels. The different braking forces may lead to the driver's unexpected behavior of the vehicle and cause the driver to feel uncomfortable in the braking state of the vehicle.

In the vehicle of the invention and the control method of the vehicle, there is a need of preventing the driver from feeling uncomfortable in the braking state of the vehicle. In the vehicle of the invention and the control method of the vehicle, there is also a need of stabilizing the behavior of the vehicle in the braking state.

In order to attain at least part of the above and the other related objects, the vehicle of the invention and the corresponding control method of the vehicle have the configurations discussed below.

The present invention is directed to a vehicle which has multiple wheels. The vehicle includes: a fluid pressure braking structure including multiple braking systems respectively having a pressurization unit for pressurization of an operation fluid and respectively related to specific wheels selected among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units; a behavior detection module that detects a behavior of the vehicle in a braking state; and a braking control module that controls the fluid pressure braking structure to satisfy a braking force demand required by the driver with correction of the pressure increase by the pressurization unit based on the detected behavior of the vehicle in the case of generation of a braking force in response to the driver's braking operation by utilizing the operational pressure and the pressure increase by the pressurization units of the multiple braking systems.

The vehicle of the invention has the fluid pressure braking structure including the multiple braking systems. Each of the multiple braking systems has the pressurization unit for pressurization of the operation fluid and is related to the specific wheels selected among the multiple wheels. The multiple braking systems of the fluid pressure braking structure utilize the operational pressure of the operation fluid produced by the driver's braking operation and the pressure increase induced by pressurization of the operation fluid by the respective pressurization units to generate a braking force. In the case of generation of a braking force demand required by the driver in response to the driver's braking operation based on the operational pressure and the pressure increase by the pressurization units of the multiple braking systems, the vehicle of the invention controls the fluid pressure braking structure to satisfy the braking force demand with correction of the pressure increase according to the behavior of the vehicle detected in the braking state. There may be a variation in pressure increase between the respective pressurization units included in the multiple braking systems due to, for example, the individual variability. Such correction of the pressure increase by the respective pressurization units based on the detected behavior of the vehicle in the braking state, however, desirably reduces a potential difference in braking force between the multiple braking systems, which is caused by the variation in pressure increase between the respective pressurization units. The vehicle of the invention thus effectively stabilizes the behavior of the vehicle in the braking state, while preventing the driver from feeling uncomfortable in the braking state of the vehicle.

In one preferable embodiment of the invention, the vehicle further includes: a braking force demand setting module that sets the braking force demand required by the driver in response to the driver's braking operation; a pressure increase command value setting module that sets a pressure increase command value for each pressurization unit included in each of the multiple braking systems based on the set braking force demand; and a correction module that sets a correction value for the pressure increase command value of each pressurization unit based on both a behavior of the vehicle detected in a non-pressure increase braking state without actuation of any pressurization unit and a behavior of the vehicle detected in a pressure increase braking state with actuation of the respective pressurization units. And the braking control module controls the fluid pressure braking structure to satisfy the braking force demand in response to the driver's braking operation with actuation of each pressurization unit based on the set pressure increase command value and the set correction value. There may be a variation in pressure increase between the respective pressurization units included in the multiple braking systems due to, for example, the individual variability. The variation in pressure increase causes different behaviors of the vehicle in the non-pressure increase braking state and in the pressure increase braking state. The vehicle of this aspect sets the correction value for the pressure increase command value of each pressurization unit, based on both the behavior of the vehicle detected in the non-pressure increase braking state and the behavior of the vehicle detected in the pressure increase braking state. This arrangement effectively reduces the potential difference in braking force between the multiple braking systems, which is caused by the variation in pressure increase between the respective pressurization units.

In another preferable embodiment of the vehicle of the invention, the behavior detection module includes an actual yaw rate detection unit that detects an actual yaw rate of the vehicle. The vehicle of this aspect ensures accurate detection of the behaviors of the vehicle in the non-pressure increase braking state and in the pressure increase braking state. The accurate detection of the behaviors more effectively reduces the potential difference in braking force between the multiple braking systems, which is caused by the variation in pressure increase between the respective pressurization units.

Instill another preferable embodiment of the invention, the vehicle further includes: a target yaw rate setting module that sets a target yaw rate of the vehicle; and a yaw rate deviation obtainment module that obtains a yaw rate deviation as a difference between the detected actual yaw rate and the set target yaw rate. And the correction module sets the correction value for the pressure increase command value of each pressurization unit based on a difference between a yaw rate deviation in the pressure increase braking state and a yaw rate deviation in the non-pressure increase braking state.

In still another preferable embodiment of the vehicle of the invention, the fluid pressure braking structure utilizes the multiple braking systems to individually apply a braking force to at least one pair of left and right wheels. There may be a potential difference in braking force between one pair of left and right wheels, which is caused by the variation in pressure increase between the respective pressurization units. The vehicle of this aspect, however, desirably reduces such a potential difference in braking force.

In still another preferable embodiment of the invention, the vehicle further includes: a motor capable of producing at least a regenerative braking force; and an accumulator unit that transmits electric power to and from the motor. And the pressure increase command value setting module sets the pressure increase command value of each pressurization unit based on the set braking force demand, the regenerative braking force produced by the motor, and an operational braking force based on the operational pressure of the operation fluid. When the sum of the regenerative braking force produced by the motor and the operational braking force based on the operational pressure of the operation fluid is less than the braking force demand required by the driver, the vehicle of this aspect utilizes the braking force based on the pressure increase by each pressurization unit. This arrangement ensures satisfaction of the braking force demand required by the driver.

Instill another preferable embodiment of the invention, the vehicle further includes: an internal combustion engine capable of outputting power to a pair of left and right first wheels. And the motor is capable of inputting and outputting power from and to a pair of left and right second wheels different from the pair of left and right first wheels, and the fluid pressure braking structure includes two braking systems of a cross arrangement as the multiple braking systems.

The present invention is directed to a control method of a vehicle. The vehicle includes: multiple wheels; and a fluid pressure braking structure including multiple braking systems respectively having a pressurization unit for pressurization of an operation fluid and respectively related to specific wheels selected among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units. The control method includes the steps of: controlling the fluid pressure braking structure to satisfy a braking force demand required by the driver with correction of the pressure increase by the pressurization unit based on a behavior of the vehicle detected in a braking state in the case of generation of a braking force in response to the driver's braking operation by utilizing the operational pressure and the pressure increase by the pressurization units of the multiple braking systems.

In the control method of the vehicle of the invention, there may be a variation in pressure increase between the respective pressurization units included in the multiple braking systems due to, for example, the individual variability. Such correction of the pressure increase by the respective pressurization units based on the detected behavior of the vehicle in the braking state, however, desirably reduces a potential difference in braking force between the multiple braking systems, which is caused by the variation in pressure increase between the respective pressurization units. The control method of the vehicle of the invention thus effectively stabilizes the behavior of the vehicle in the braking state, while preventing the driver from feeling uncomfortable in the braking state of the vehicle.

In one preferable embodiment of the control method of the vehicle of the invention, the control method further includes: setting the braking force demand required by the driver in response to the driver's braking operation; setting a pressure increase command value for each pressurization unit included in each of the multiple braking systems based on the set braking force demand; and setting a correction value for the pressure increase command value of each pressurization unit based on both a behavior of the vehicle detected in a non-pressure increase braking state without actuation of any pressurization unit and a behavior of the vehicle detected in a pressure increase braking state with actuation of the respective pressurization units. And the controlling step controls the fluid pressure braking structure to satisfy the braking force demand in response to the driver's braking operation with actuation of each pressurization unit based on the set pressure increase command value and the set correction value.

In another preferable embodiment of the control method of the invention, the vehicle further includes an actual yaw rate detection unit that detects an actual yaw rate of the vehicle as the behavior of the vehicle.

Instill another preferable embodiment of the invention, the control method of the vehicle further includes: setting a target yaw rate of the vehicle; and obtaining a yaw rate deviation as a difference between the detected actual yaw rate and the set target yaw rate. And the step of setting a correction value sets the correction value for the pressure increase command value of each pressurization unit based on a difference between a yaw rate deviation in the pressure increase braking state and a yaw rate deviation in the non-pressure increase braking state.

In still another preferable embodiment of the control method of the vehicle of the invention, the fluid pressure braking structure utilizes the multiple braking systems to individually apply a braking force to at least one pair of left and right wheels.

In still another preferable embodiment of the control method of the invention, the vehicle further includes: a motor capable of producing at least a regenerative braking force; and an accumulator unit that transmits electric power to and from the motor. And the step of setting a pressure increase command value sets the pressure increase command value of each pressurization unit based on the set braking force demand, the regenerative braking force produced by the motor, and an operational braking force based on the operational pressure of the operation fluid.

In still another preferable embodiment of the control method of the invention, the vehicle further includes an internal combustion engine capable of outputting power to a pair of left and right first wheels. And the motor is capable of inputting and outputting power from and to a pair of left and right second wheels different from the pair of left and right first wheels, and the fluid pressure braking structure includes two braking systems of a cross arrangement as the multiple braking systems.

### BRIEF DESCRIPTION OF THE DRAWINGS

FIG. 1 schematically illustrates the configuration of a hybrid vehicle in one embodiment of the invention;

FIG. 2 is a schematic diagram showing the structure of a brake actuator in an HBS mounted on the hybrid vehicle of the embodiment;

FIG. 3 is a flowchart showing a braking control routine executed by a brake ECU in the hybrid vehicle of the embodiment;

FIG. 4 shows one example of a regenerative braking force computation map;

FIG. 5 shows one example of a pedal force setting map;

FIG. 6 shows one example of a braking force demand setting map; and

FIG. 7 is a flowchart showing a pump command correction value setting routine executed by the brake ECU in the hybrid vehicle of the embodiment.

### DESCRIPTION OF THE PREFERRED EMBODIMENTS

One mode of carrying out the invention is described below as a preferred embodiment with reference to the accompanied drawings.

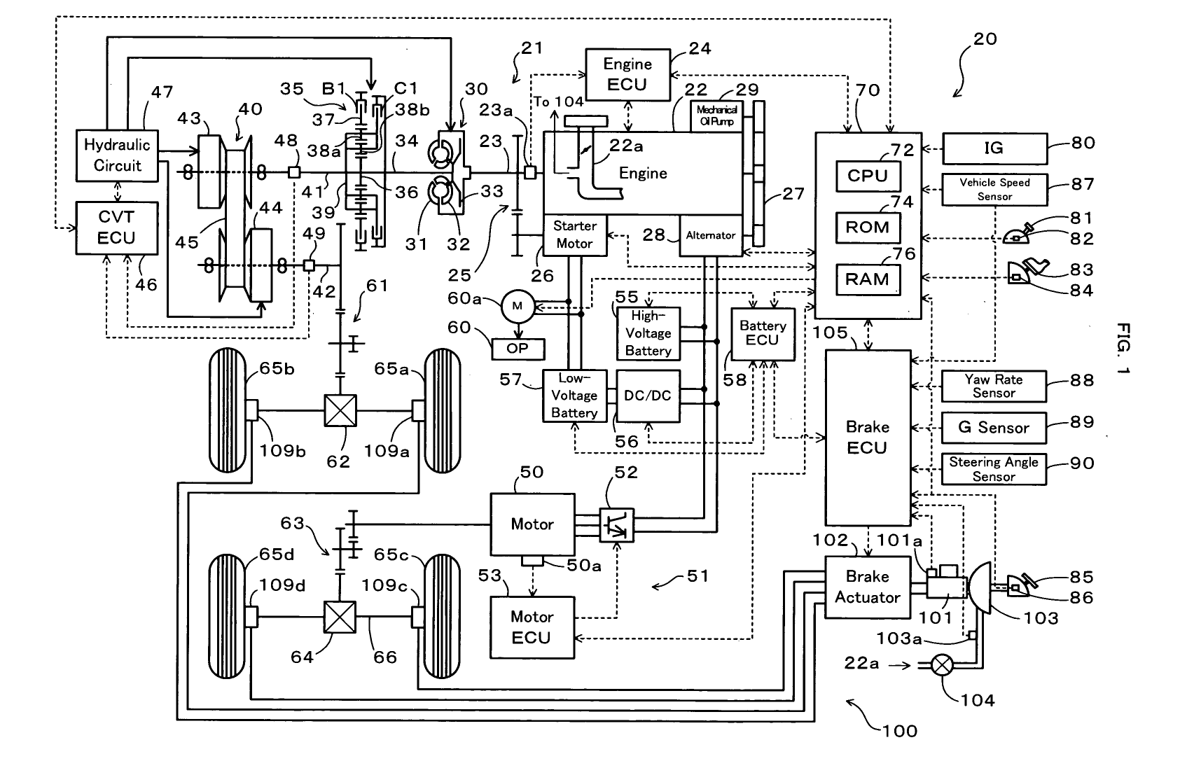

FIG. 1 schematically illustrates the configuration of a hybrid vehicle 20 in the embodiment of the invention. The hybrid vehicle 20 of the embodiment has a front wheel driving system 21 for transmission of output power of an engine 22 to front wheels 65a and 65b via a torque converter 30, a forward-backward drive switchover mechanism 35, a belt-driven continuously variable transmission (hereafter referred to as ‘CVT’) 40, a gear mechanism 61, and a differential gear 62, a rear wheel driving system 51 for transmission of output power of a motor 50 to rear wheels 65c and 65d via a gear mechanism 63, a differential gear 64, and a rear axle 66, an electronically controlled hydraulic braking system (hereafter referred to as ‘HBS’) 100 for application of braking force to the front wheels 65a and 65b and to the rear wheels 65c and 65d, and a hybrid electronic control unit (hereafter referred to as ‘hybrid ECU’) 70 for controlling the operations of the whole hybrid vehicle 20.

The engine 22 is an internal combustion engine that consumes a hydrocarbon fuel, such as gasoline or light oil, to output the power. A crankshaft 23 as an output shaft of the engine 22 is linked to the torque converter 30. The crankshaft 23 is also connected with a starter motor 26 via a gear train 25 and with an alternator 28 and a mechanical oil pump 29 via a belt 27. The engine 22 is driven and operated under control of an engine electronic control unit (hereafter referred to as ‘engine ECU’) 24. The engine ECU 24 receives input signals from various sensors measuring and detecting the operation conditions of the engine 22, for example, a crank position signal from a crank position sensor 23a attached to the crankshaft 23. The engine ECU 24 regulates the amount of fuel injection and the amount of intake air and adjusts the ignition timing, in response to these input signals. The engine ECU 24 makes communication with the hybrid ECU 70 to control the operation of the engine 22 in response to control signals from the hybrid ECU 70 and to output data regarding the operating conditions of the engine 22 to the hybrid ECU 70 according to the requirements.

The torque converter 30 of this embodiment is a fluid-type torque converter with a lockup clutch. The torque converter 30 includes a turbine runner 31 connected to the crankshaft 23 of the engine 22, a pump impeller 32 connected to an input shaft 41 of the CVT 40 via the forward-backward drive switchover mechanism 35, and a lockup clutch 33. The lockup clutch 33 is actuated by means of hydraulic pressure applied by a hydraulic circuit 47, which is driven and operated under control of a CVT electronic control unit (hereafter referred to as ‘CVTECU’) 46. The lockup clutch 33 locks up the turbine runner 31 and the pump impeller 32 of the torque converter 30 when required.

The forward-backward drive switchover mechanism 35 includes a double-pinion planetary gear mechanism, a brake B1, and a clutch C1. The double-pinion planetary gear mechanism includes a sun gear 36 as an external gear, a ring gear 37 as an internal gear arranged concentrically with the sun gear 36, multiple first pinion gears 38a engaging with the sun gear 36, multiple second pinion gears 38b engaging with the respective first pinion gears 38a and with the ring gear 37, and a carrier 39 connecting and holding the multiple first pinion gears 38a and the multiple second pinion gears 38b to allow both their revolutions and their rotations on their axes. The sun gear 36 and the carrier 39 are respectively linked to an output shaft 34 of the torque converter 30 and to the input shaft 41 of the CVT 40. The ring gear 37 of the planetary gear mechanism is fixed to a casing (not shown) via the brake B1. The on-off setting of the brake B1 freely prohibits and allows rotation of the ring gear 37. The sun gear 36 and the carrier 39 of the planetary gear mechanism are interconnected via the clutch C1. The on-off setting of the clutch C1 couples and decouples the sun gear 36 with and from the carrier 39. In the forward-backward drive switchover mechanism 35 of this structure, in the off position of the brake B1 and the on position of the clutch C1, the rotation of the output shaft 34 of the torque converter 30 is directly transmitted to the input shaft 41 of the CVT 40 to move the hybrid vehicle 20 forward. In the on position of the brake B1 and the off position of the clutch C1, the rotation of the output shaft 34 of the torque converter 30 is inverted to the reverse direction and is transmitted to the input shaft 41 of the CVT 40 to move the hybrid vehicle 20 backward. In the off positions of both the brake B1 and the clutch C1, the output shaft 34 of the torque converter 30 is decoupled from the input shaft 41 of the CVT 40.

The CVT 40 includes a primary pulley 43 of variable groove width linked to the input shaft 41, a secondary pulley 44 of variable groove width linked to an output shaft 42 or a driveshaft, and a belt 45 set in the grooves of the primary pulley 43 and the secondary pulley 44. The groove widths of the primary pulley 43 and the secondary pulley 44 are varied by the hydraulic pressure generated by the hydraulic circuit 47 under operation control of the CVTECU 46. Varying the groove widths enables the input power of the input shaft 41 to go through the continuously variable speed change and to be output to the output shaft 42. The groove widths of the primary pulley 43 and the secondary pulley 44 are varied to regulate the clamping force of the belt 45 for adjustment of the transmission torque capacity of the CVT 40, as well as to vary the change gear ratio. The hydraulic circuit 47 regulates the pressure and the flow rate of brake oil (operational fluid) fed by an electric oil pump 60, which is driven by a motor 60a, and by the mechanical oil pump 29, which is driven by the engine 22, and supplies the brake oil of the regulated pressure and flow rate to the primary pulley 43, the secondary pulley 44, the torque converter 30 (lockup clutch 33), the brake B1, and the clutch C1. The CVTECU 46 inputs a rotation speed Nin of the input shaft 41 from a rotation speed sensor 48 attached to the input shaft 41 and a rotation speed Nout of the output shaft 42 from a rotation speed sensor 49 attached to the output shaft 42. The CVTECU 46 generates and outputs driving signals to the hydraulic circuit 47, in response to these input data. The CVTECU 46 also controls on and off the brake B1 and the clutch C1 of the forward-backward drive switchover mechanism 35 and performs the lockup control of the torque converter 30. The CVTECU 46 makes communication with the hybrid ECU 70 to regulate the change gear ratio of the CVT 40 in response to control signals from the hybrid ECU 70 and to output data regarding the operating conditions of the CVT 40, for example, the rotation speed Nin of the input shaft 41 and the rotation speed Nout of the output shaft 42, to the hybrid ECU 70 according to the requirements.

The motor 50 is constructed as a known synchronous motor generator that may be actuated both as a generator and as a motor. The motor 50 is connected with the alternator 28, which is driven by the engine 22, via an inverter 52 and with a high-voltage battery 55 (for example, a secondary battery having a rated voltage of 42 V) having its output terminal linked to a power line from the alternator 28. The motor 50 is accordingly driven with electric power supplied from the alternator 28 or from the high-voltage battery 55 and generates regenerative electric power during deceleration to charge the high-voltage battery 55. The motor 50 is driven and operated under control of a motor electronic control unit (hereafter referred to as ‘motor ECU’) 53. The motor ECU 53 receives input signals required for the operation control of the motor 50, for example, signals from a rotational position detection sensor 50a that detects the rotational position of a rotor in the motor 50 and values of phase current for the motor 50 from a current sensor (not shown). The motor ECU 53 generates and outputs switching signals to switching elements included in the inverter 52, in response to these input signals. The motor ECU 53 makes communication with the hybrid ECU 70 to output switching control signals to the inverter 52 for the operation control of the motor 50 in response to control signals from the hybrid ECU 70 and to output data regarding the operating conditions of the motor 50 to the hybrid ECU 70 according to the requirements. The high-voltage battery 55 is connected with a low-voltage battery 57 via a DC-DC converter 56 having the function of voltage conversion. The electric power supplied from the high-voltage battery 55 goes through the voltage conversion by the DC-DC converter 56 and is transmitted to the low-voltage battery 57. The low-voltage battery 57 is used as the power source of various auxiliary machines including the electric oil pump 60. Both the high-voltage battery 55 and the low-voltage battery 57 are under management and control of a battery electronic control unit (hereafter referred to as ‘battery ECU’) 58. The battery ECU 58 computes remaining charge levels or states of charge (SOC) and input and output limits of the high-voltage battery 55 and the low-voltage battery 57, based on inter-terminal voltages from voltage sensors (not shown) attached to the respective output terminals (not shown) of the high-voltage battery 55 and the low-voltage battery 57, charge-discharge electric currents from current sensors (not shown), and battery temperatures from temperature sensors (not shown). The battery ECU 58 makes communication with the hybrid ECU 70 to output data regarding the conditions of the high-voltage battery 55 and the low-voltage battery 57, for example, their states of charge (SOC), to the hybrid ECU 70 according to the requirements.

The HBS 100 mounted on the hybrid vehicle 20 has a master cylinder 101, a brake actuator 102, and wheel cylinders 109a through 109d respectively provided for the front wheels 65a and 65b and the rear wheels 65c and 65d. The HBS 100 supplies a master cylinder pressure Pmc to the wheel cylinders 109a through 109d for the front wheels 65a and 65b and the rear wheels 65c and 65d via the brake actuator 102, so as to apply master cylinder pressure Pmc-based braking force to the front wheels 65a and 65b and the rear wheels 65c and 65d. The master cylinder pressure Pmc is generated by the master cylinder 101 as an operation pressure in response to the driver's depression of a brake pedal 85. In the HBS 100 of this embodiment, the master cylinder 101 is provided with a brake booster 103 that utilizes a negative pressure Pn produced by the engine 22 to assist the driver's braking operation. As shown in FIG. 1, the brake booster 103 is connected to an intake manifold 22a of the engine 22 via piping and a check valve 104 and works as a vacuum power-boosting device. The brake booster 103 utilizes the force applied to a diaphragm (not shown) due to a differential pressure between the outside air pressure and the negative intake pressure of the engine 22 and amplifies the driver's pressing force of the brake pedal 85. A piston (not shown) in the master cylinder 101 receives the driver's pressing force of the brake pedal 85 and the assist of negative pressure in the brake booster 103 and pressurizes the brake oil. The master cylinder 101 accordingly generates the master cylinder pressure Pmc corresponding to the driver's pressing force of the brake pedal 85 and the negative pressure Pn of the engine 22.

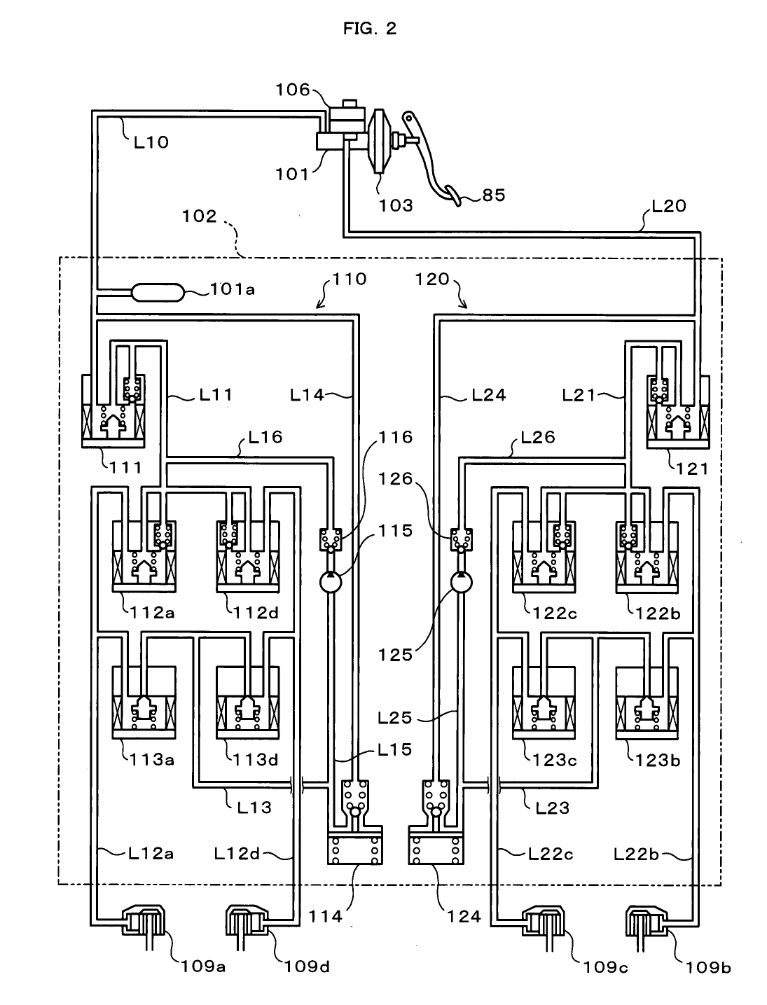

The brake actuator 102 is actuated by the low-voltage battery 57 as the power source. The brake actuator 102 regulates the master cylinder pressure Pmc generated by the master cylinder 101 and supplies the regulated master cylinder pressure Pmc to the wheel cylinders 109a through 109d, while adjusting the hydraulic pressure in the wheel cylinders 109a through 109d to ensure application of braking force to the front wheels 65a and 65b and the rear wheels 65c and 65d regardless of the driver's pressing force of the brake pedal 85. FIG. 2 is a system diagram showing the structure of the brake actuator 102. As shown in FIG. 2, the brake actuator 102 is constructed in cross arrangement and has a first system 110 for the right front wheel 65a and the left rear wheel 65d and a second system 120 for the left front wheel 65b and the right rear wheel 65c. In the hybrid vehicle 20 of this embodiment, the engine 22 for driving the front wheels 65a and 65b is placed in the front portion of the vehicle body to give the front-deviated weight balance. The brake actuator 102 of the cross arrangement ensures application of braking force to at least one of the front wheels 65a and 65b even in the event of some failure in either the first system 110 or the second system 120. In this embodiment, the specification of the brake actuator 102 is determined to ensure application of the greater braking force to the front wheels 65a and 65b than the braking force applied to the rear wheels 65c and 65d, when the hydraulic pressure (wheel cylinder pressure) in the wheel cylinders 109a and 109b for the front wheels 65a and 65b is equal to the hydraulic pressure (wheel cylinder pressure) in the wheel cylinders 109c and 109d for the rear wheels 65c and 65d. The specification of the brake actuator 102 includes the friction coefficient of brake pads and the outer diameter of rotors in friction brake units, for example, disk brakes or drum brakes, which receive the hydraulic pressure from the wheel cylinders 109a through 109d to generate frictional braking force.

The first system 110 includes a master cylinder cut solenoid valve (hereafter referred to as ‘MC cut solenoid valve’) 111 connected with the master cylinder 101 via an oil supply path L10, and holding solenoid valves 112a and 112d linked to the MC cut solenoid valve 111 via an oil supply path L11 and respectively connected with the wheel cylinder 109a for the right front wheel 65a and with the wheel cylinder 109d for the left rear wheel 65d via pressure-varying oil paths L12a and L12d. The first system 110 also includes pressure reduction solenoid valves 113a and 113d respectively connected with the wheel cylinder 109a for the right front wheel 65a and with the wheel cylinder 109d for the left rear wheel 65d via the pressure-varying oil paths L12a and L12d, a reservoir 114 linked to the pressure reduction solenoid valves 113a and 113d via a pressure reduction oil path L13 and to the oil supply path L10 via an oil path L14, and a pump 115 having an inlet connected to the reservoir 114 via an oil path L15 and an outlet connected to the oil supply path L11 via an oil path L16 with a check valve 116. Similarly the second system 120 includes an MC cut solenoid valve 121 connected with the master cylinder 101 via an oil supply path L20, and holding solenoid valves 122b and 122c linked to the MC cut solenoid valve 121 via an oil supply path L21 and respectively connected with the wheel cylinder 109b for the left front wheel 65b and with the wheel cylinder 109c for the right rear wheel 65c via pressure-varying oil paths L22b and L22c. The second system 120 also includes pressure reduction solenoid valves 123b and 123c respectively connected with the wheel cylinder 109b for the left front wheel 65b and with the wheel cylinder 109c for the right rear wheel 65c via the pressure-varying oil paths L22b and L22c, a reservoir 124 linked to the pressure reduction solenoid valves 123b and 123c via a pressure reduction oil path L23 and to the oil supply path L20 via an oil path L24, and a pump 125 having an inlet connected to the reservoir 124 via an oil path L25 and an outlet connected to the oil supply path L21 via an oil path L26 with a check valve 126.

The MC cut solenoid valve 111, the holding solenoid valves 112a and 112d, the pressure reduction solenoid valves 113a and 113d, the reservoir 114, the pump 115, and the check valve 116 included in the first system 110 respectively correspond to and are identical with the MC cut solenoid valve 121, the holding solenoid valves 122b and 122c, the pressure reduction solenoid valves 123b and 123c, the reservoir 124, the pump 125, and the check valve 126 included in the second system 120. Each of the MC cut solenoid valves 111 and 121 is a linear solenoid valve that is full open in the power cut-off condition (off position) and has the opening adjustable by regulation of the electric current supplied to a solenoid. Each of the holding solenoid valves 112a, 112d, 122b, and 122c is a normally-open solenoid valve that is closed in the power supply condition (on position). Each of the holding solenoid valves 112a, 112d, 122b, and 122c has a check valve activated to return the flow of brake oil to the oil supply path L11 or L21 when the wheel cylinder pressure in the corresponding one of the wheel cylinders 109a through 109d is higher than the hydraulic pressure in the oil supply path L11 or L21 in the closed position of the holding solenoid valve 112a, 112d, 122b, or 122c under the power supply condition (on position). Each of the pressure reduction solenoid valves 113a, 113d, 123b, and 123c is a normally-closed solenoid valve that is opened in the power supply condition (on position). The pump 115 of the first system 110 and the pump 125 of the second system 120 are actuated by respective non-illustrated drive motors (for example, duty-controlled brushless DC motors). The pump 115 or 125 takes in and pressurizes the brake oil in the corresponding reservoir 114 or 124 and supplies the pressurized brake oil to the oil path L16 or L26.

The brake actuator 102 of the above construction has the operations described below. In the off position of all the MC cut solenoid valves 111 and 121, the holding solenoid valves 112a, 112d, 122b, and 122c, and the pressure reduction solenoid valves 113a, 113d, 123b, and 123c (in the state of FIG. 2), in response to the driver's depression of the brake pedal 85, the master cylinder 101 generates the master cylinder pressure Pmc corresponding to the driver's pressing force of the brake pedal 85 and the negative pressure Pn of the engine 22. The brake oil is then supplied to the wheel cylinders 109a through 109d via the oil supply paths L10 and L20, the MC cut solenoid valves 111 and 121, the oil supply paths L11 and L21, the holding solenoid valves 112a, 112d, 122b, and 122c, and the pressure-varying oil paths L12a, L12d, L22b, and L22c. The master cylinder pressure Pmc-based braking force is thus applied to the front wheels 65a and 65b and the rear wheels 65c and 65d. In response to the driver's subsequent release of the brake pedal 85, the brake oil in the wheel cylinders 109a through 109d is returned to a reservoir 106 of the master cylinder 101 via the pressure-varying oil paths L12a, L12d, L22b, and L22c, the holding solenoid valves 112a, 112d, 122b, and 122c, the oil supply paths L11 and L21, the MC cut solenoid valves 111 and 121, and the oil supply paths L10 and L20. This decreases the hydraulic pressure in the wheel cylinders 109a through 109d to release the braking force applied to the front wheels 65a and 65b and the rear wheels 65c and 65d. During application of the braking force to the front wheels 65a and 65b and the rear wheels 65c and 65d, the power supply to close the holding solenoid valves 112a, 112d, 122b, and 122c (on position) keeps the hydraulic pressure in the wheel cylinders 109a through 109d. The power supply to open the pressure reduction solenoid valves 113a, 113d, 123b, and 123c (on position) introduces the brake oil in the wheel cylinders 109a through 109d to the reservoirs 114 and 124 via the pressure-varying oil paths L12a, L12d, L22b, and L22c, the pressure reduction solenoid valves 113a, 113d, 123b, and 123c, and the pressure reduction oil paths L13 and L23 to reduce the wheel cylinder pressure in the wheel cylinders 109a through 109d. The brake actuator 102 accordingly attains antilock braking (ABS) control to prevent a skid of the hybrid vehicle 20 due to the lock of any of the front wheels 65a and 65b and the rear wheels 65c and 65d in response to the driver's depression of the brake pedal 85.

On the driver's depression of the brake pedal 85, the brake actuator 102 actuates the pumps 115 and 125 with reduction of the openings of the MC cut solenoid valves 111 and 121 to introduce the brake oil from the master cylinder 101 to the reservoirs 114 and 124. The brake oil introduced from the master cylinder 101 to the reservoirs 114 and 124 has the pressure increased by the pumps 115 and 125 and is fed to the wheel cylinders 109a through 109d via the oil paths L16 and L26, the holding solenoid valves 112a, 112d, 122b, and 122c, and the pressure-varying oil paths L12a, L12d, L22b, and L22c. Actuation of the pumps 115 and 125 simultaneously with the opening adjustment of the MC cut solenoid valves 111 and 121 attains the braking assist and gives the braking force as the sum of the master cylinder pressure Pmc and the pressure increase by the pumps 115 and 125. Even in the state of the driver's release of the brake pedal 85, actuation of the pumps 115 and 125 simultaneously with the opening adjustment of the MC cut solenoid valves 111 and 121 enables the brake oil introduced from the reservoir 106 of the master cylinder 101 to the reservoirs 114 and 124 of the brake actuator 102 to be pressurized by the pumps 115 and 125 and to be fed to the wheel cylinders 109a through 109d. The individual on-off control of the holding solenoid valves 112a, 112d, 122b, and 122c and the pressure reduction solenoid valves 113a, 113d, 123b, and 123c individually and freely regulates the pressure in each of the wheel cylinders 109a through 109d. The brake actuator 102 thus attains traction control (TRC) to prevent a skid of the hybrid vehicle 20 due to the wheelspin of any of the front wheels 65a and 65b and the rear wheels 65c and 65d in response to the driver's depression of the accelerator pedal 83. The brake actuator 102 also attains attitude stabilization control (VSC) to prevent a sideslip of any of the front wheels 65a and 65b and the rear wheels 65c and 65d, for example, during a turn of the hybrid vehicle 20.

The brake actuator 102 is driven and operated under control of a brake electronic control unit (hereafter referred to as ‘brake ECU’) 105. More specifically the brake ECU 105 controls the operations of the MC cut solenoid valves 111 and 121, the holding solenoid valves 112a, 112d, 122b, and 122c, the pressure reduction solenoid valves 113a, 113d, 123b, and 123c, and the motor for actuating the pumps 115 and 125. The brake ECU 105 inputs the master cylinder pressure Pmc generated by the master cylinder 101 and measured by a master cylinder pressure sensor 101a, a negative pressure Pn in the brake booster 103 produced by the engine 22 and measured by a pressure sensor 103a, a signal from a pedal force detection switch 86 attached to the brake pedal 85 and mainly used in the event of a failure of the brake actuator 102, an actual yaw rate Yr from a yaw rate sensor 88 measured as a rotational angular velocity about the center of gravity of the vehicle, an anterior-posterior acceleration Gx and a lateral acceleration Gy from a G sensor 89 measured as accelerations of the vehicle in the anterior-posterior direction and in the lateral direction, a steering angle θ of a steering mechanism (not shown) from a steering angle sensor 90, and wheel speeds from wheel speed sensors (not shown). The brake ECU 105 makes communication with the hybrid ECU 70, the motor ECU 53, and the battery ECU 58. The brake ECU 105 controls the operation of the brake actuator 102 according to the input data including the master cylinder pressure Pmc and the negative pressure Pn, the state of charge (SOC) of the high-voltage battery 55, a rotation speed Nm of the motor 50, and control signals from the hybrid ECU 70, so as to attain the braking assist, the ABS control, the TRC, and the VSC. The brake ECU 105 outputs the operating conditions of the brake actuator 102 to the hybrid ECU 70, the motor ECU 53, and the battery ECU 58 according to the requirements.

The hybrid ECU 70 is constructed as a microprocessor including a CPU 72, a ROM 74 that stores processing programs, a RAM 76 that temporarily stores data, input and output ports (not shown), and a communication port (not shown). The hybrid ECU 70 receives, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a signal from the pedal force detection switch 86, and a vehicle speed V from a vehicle speed sensor 87. The hybrid ECU 70 generates diverse control signals in response to these input signals and transmits control signals and data to and from the engine ECU 24, the CVTECU 46, the motor ECU 53, the battery ECU 58, and the brake ECU 105 by communication. The hybrid ECU 70 outputs, via its output port, for example, driving signals to the starter motor 26 and the alternator 28 linked to the crankshaft 23 and control signals to the motor 60a for the electric oil pump 60.

In response to the driver's operation of the accelerator pedal 83, the hybrid vehicle 20 of the embodiment may be driven with the output power of the engine 22 transmitted to the front wheels 65a and 65b, with the output power of the motor 50 transmitted to the rear wheels 65c and 65d, or with both the output power of the engine 22 and the output power of the motor 50 as the four-wheel drive. The hybrid vehicle 20 is driven by the four-wheel drive, for example, in the event of abrupt acceleration by the driver's heavy depression of the accelerator pedal 83 or in the event of a skid or slip of any of the front wheels 65a and 65b and the rear wheels 65c and 65d. When the driver releases the accelerator pedal 83 to give an accelerator off-based speed reduction requirement at the vehicle speed V of not lower than a predetermined level, the hybrid vehicle 20 of the embodiment sets both the brake B1 and the clutch C1 off to decouple the engine 22 from the CVT 40, stops the operation of the engine 22, and performs the regenerative control of the motor 50. The regenerative control of the motor 50 applies the braking force to the rear wheels 65c and 65d to decelerate the hybrid vehicle 20. The regenerative electric power generated by the motor 50 during deceleration may be used to charge the high-voltage battery 55. This arrangement desirably enhances the energy efficiency in the hybrid vehicle 20.

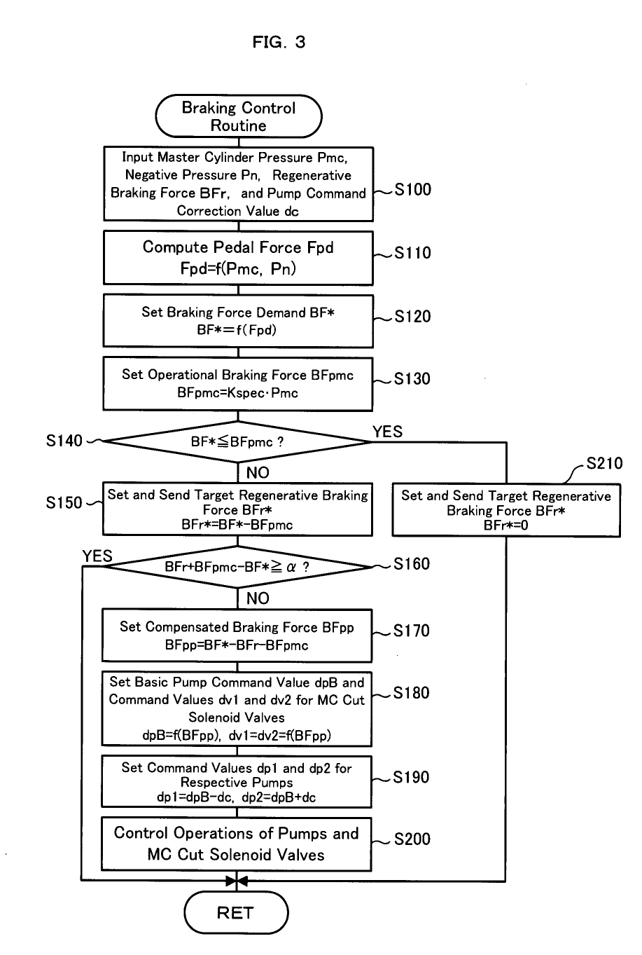

The following describes the operations in the hybrid vehicle 20 of the embodiment having the above configuration, especially a series of braking control in response to the driver's depression of the brake pedal 85. FIG. 3 is a flowchart showing a braking control routine executed by the brake ECU 105 in the hybrid vehicle 20 of the embodiment. This braking control routine is repeatedly executed at preset time intervals, for example, at every several msec, during the driver's depression of the brake pedal 85.

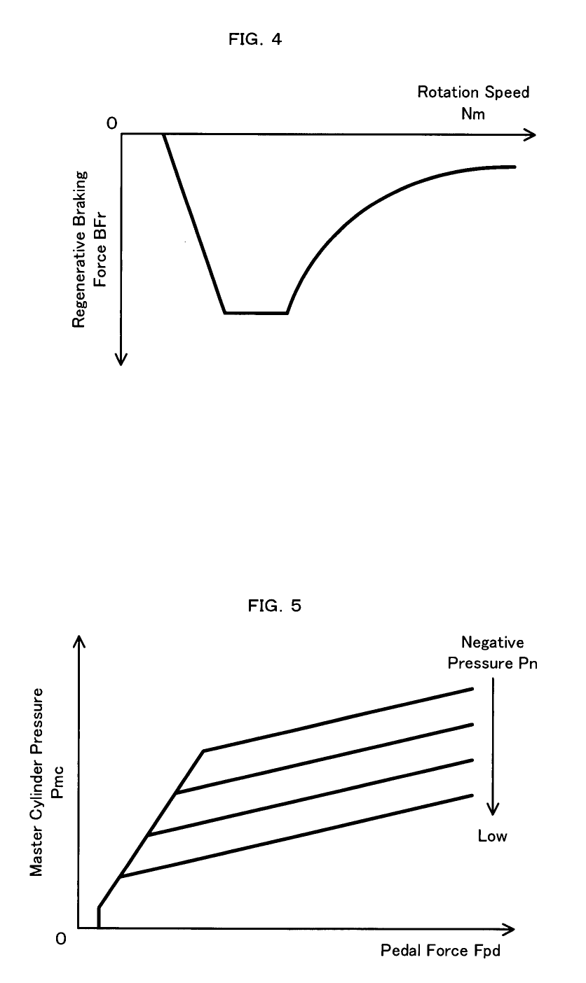

On the start of the braking control routine shown in FIG. 3, a CPU (not shown) of the brake ECU 105 first inputs required data for control, that is, the master cylinder pressure Pmc from the master cylinder pressure sensor 101a, the negative pressure Pn from the pressure sensor 103a, a regenerative braking force BFr obtained by regeneration of the motor 50, and a pump command correction value dc (step S100). The regenerative braking force BFr obtained by regeneration of the motor 50 is set corresponding to the rotation speed Nm of the motor 50 and the state of charge SOC of the high-voltage battery 55 and is received from the hybrid ECU 70 by communication. In this embodiment, a relation between the regenerative braking force BFr and the rotation speed Nm of the motor 50 is specified in advance with regard to each charge level or state of charge SOC of the high-voltage battery 55, based on the rated regenerative torque of the motor 50. The specified relation is stored as a regenerative braking force computation map in the ROM 74 of the hybrid ECU 70. One example of the regenerative braking force computation map is shown in FIG. 4. The hybrid ECU 70 selects a regenerative braking force computation map corresponding to the state of charge SOC of the high-voltage battery 55 input from the battery ECU 58 at every preset time interval and reads the regenerative braking force BFr corresponding to the given rotation speed Nm of the motor 50 from the selected regenerative braking force computation map. The regenerative braking force BFr input at step S100 is thus basically the value sampled immediately before the input. The pump command correction value dc input at step S100 has been set by a pump command correction value setting routine described later and stored in a specific storage area of the brake ECU 105.

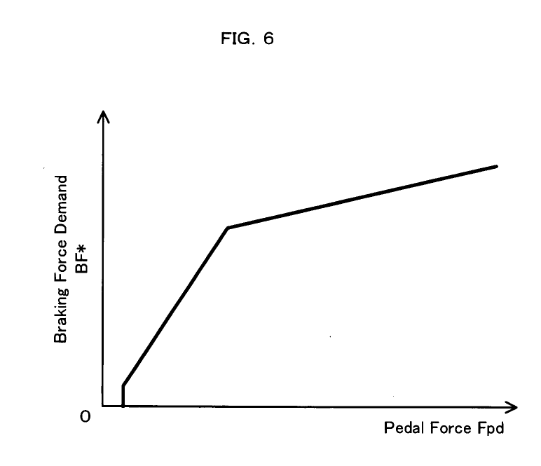

After the data input at step S100, the CPU computes a pedal force Fpd applied by the driver's depression of the brake pedal 85 from the input master cylinder pressure Pmc and the input negative pressure Pn (step S110). The procedure of this embodiment prepares and stores in advance variations in pedal force Fpd against the master cylinder pressure Pmc and the negative pressure Pn as a pedal force setting map in a ROM (not shown) of the brake ECU 105 and reads the pedal force Fpd corresponding to the given master cylinder pressure Pmc and the given negative pressure Pn from the pedal force setting map. FIG. 5 shows one example of the pedal force setting map. The CPU subsequently computes a braking force demand BF* as the driver's requirement from the set pedal force Fpd (step S120). The procedure of this embodiment prepares and stores in advance a variation in braking force demand BF* against the driver's pedal force Fpd as a braking force demand setting map in the ROM of the brake ECU 105 and reads the braking force demand BF* corresponding to the given pedal force Fpd from the braking force demand setting map. FIG. 6 shows one example of the braking force demand setting map. The servo ratio in the brake booster 103 varies with a variation in negative pressure Pn applied from the engine 22 to the brake booster 103. By taking into account this variation, the braking control of this embodiment computes the pedal force Fpd given by the driver's depression of the brake pedal 85 according to the master cylinder pressure Pmc and the negative pressure Pn and sets the braking force demand BF* corresponding to the computed pedal force Fpd. This enables accurate setting of the braking force demand BF* corresponding to the driver's requirement even in the event of a variation in negative pressure Pn applied from the engine 22 to the brake booster 103.

The master cylinder pressure Pmc input at step S100 is multiplied by a constant Kspec to set a master cylinder pressure Pmc-based operational braking force BFpmc (step S130). The constant Kspec is determined according to the braking specification including the outer diameter of the brake rotors, the diameter of the wheels, the sectional area of the wheel cylinders, and the friction coefficient of the brake pads. The braking force demand BF* computed at step S120 is compared with the operational braking force BFpmc set at step S130 (step S140).

When the braking force demand BF* is not greater than the operational braking force BFpmc, the master cylinder pressure Pmc-based operational braking force BFpmc is sufficient to satisfy the driver's required braking force. When the braking force demand BF* is not greater than the operational braking force BFpmc (step S140: yes), the CPU sets a value ‘0’ to a target regenerative braking force BFr* that is to be obtained by regeneration of the motor 50 and sends the setting of the target regenerative braking force BFr* to the motor ECU 53 (step S210). The CPU then terminates this braking control routine. In this case, the master cylinder pressure Pmc-based operational braking force BFpmc is directly transmitted to the front wheels 65a and 65b and to the rear wheels 65c and 65d. The MC cut solenoid valves 111 and 121 are thus set in the off position to be kept full open.

When the braking force demand BF* exceeds the operational braking force BFpmc, on the other hand, the master cylinder pressure Pmc-based operational braking force BFpmc is insufficient to satisfy the driver's required braking force. When the braking force demand BF* is greater than the operational braking force BFpmc (step S140: no), the CPU sets the result of subtraction of the operational braking force BFpmc set at step S130 from the braking force demand BF* computed at step S120 to the target regenerative braking force BFr* that is to be obtained by regeneration of the motor 50 and sends the setting of the target regenerative braking force BFr* to the motor ECU 53 (step S150). The regenerative braking force producible by regeneration of the motor 50 varies according to the rotation speed Nm of the motor 50 (that is, the vehicle speed V) and the state of charge SOC of the high-voltage battery 55. The target regenerative braking force BFr* set and sent at step S150 is not always coverable by the output from the motor 50. Under some conditions, the output of the motor 50 may be less than the target regenerative braking force BFr* and fail to satisfy the braking force demand BF* required by the driver. After sending the setting of the target regenerative braking force BFr* at step S150, the CPU determines whether the result of subtraction of the braking force demand BF* computed at step S120 from the sum of the regenerative braking force BFr input at step S100 and the operational braking force BFpmc set at step S130 is not less than a predetermined threshold value α (step S160). The threshold value α is determined experimentally and analytically by taking into account a variation in regenerative braking force during the driver's braking operation and is, for example, a positive value approximate to 0. In the case of an affirmative answer at step S160, the motor 50 is capable of outputting the target regenerative braking force BFr*. Namely the braking force demand BF* is satisfied by the sum of the master cylinder pressure Pmc-based operational braking force BFpmc and the regenerative braking force produced by the motor 50. The CPU then exits from the braking control routine of FIG. 3. The motor ECU 53 receives the target regenerative braking force BFr* and performs switching control of switching elements included in the inverter 52 to enable output of the target regenerative braking force BFr* from the motor 50. In this state, the master cylinder pressure Pmc-based operational braking force BFpmc is directly transmitted to the front wheels 65a and 65b and to the rear wheels 65c and 65d. The MC cut solenoid valves 111 and 121 are thus set in the off position to be kept full open.

In the case of a negative answer at step S160, on the other hand, the regenerative braking force actually output from the motor 50 is less than the target regenerative braking force BFr*. The output of the motor 50 may thus fail to satisfy the braking force demand BF* required by the driver. When BFr+BFpmc−BF* is less than the predetermined threshold value α (step S160: no), the result of subtraction of the regenerative braking force BFr input at step S100 and the operational braking force BFpmc set at step S130 from the braking force demand BF* computed at step S120 is set to a compensated braking force BFpp, which is based on a pressure increase induced by pressurization of the brake oil by the pumps 115 and 125 (step S170). The pumps 115 and 125 are actuated and controlled to pressurize the brake oil fed from the master cylinder 101 and thereby compensate for a potential insufficiency of braking force. After setting the compensated braking force BFpp, the CPU sets a basic pump command value dpB (duty ratio command value) as pressure increase command values for the motors of the pumps 115 and 125, a command value dv1 (duty ratio command value) for varying the opening of the MC cut solenoid valve 111, and a command value dv2 (duty ratio command value) for varying the opening of the MC cut solenoid valve 121, based on the compensated braking force BFpp (step S180). In this embodiment, a variation in basic pump command value dpB and variations in command values dv1 and dv2 against the compensated braking force BFpp or the pressure increase by the pumps 115 and 125 are specified and stored in advance as command value setting maps (not shown) in the ROM of the brake ECU 105. The basic pump command value dpB and the command values dv1 and dv2 are read corresponding to the given compensated braking force BFpp from these command value setting maps. The CPU then subtracts the pump command correction value dc input at step S100 from the basic pump command value dpB to set a command value dp1 for the pump 115 of the first system 110, while adding the pump command correction value dc input at step S100 to the basic pump command value dpB to set a command value dp2 for the pump 125 of the second system 120 (step S190). The operation of the motors for the pumps 115 and 125 and the operation of the solenoids of the MC cut solenoid valves 111 and 121 are controlled respectively with the command values dp1 and dp2 and with the command values dv1 and dv2 (step S200). The CPU then exits from the braking control routine of FIG. 3. In this state, the sum of the braking force based on the master cylinder pressure Pmc from the wheel cylinders 109a through 109d and the braking force based on the pressure increase by the pumps 115 and 125, that is, the sum of the operational braking force BFpmc and the compensated braking force BFpp, is transmitted to the front wheels 65a and 65b and to the rear wheels 65c and 65d.

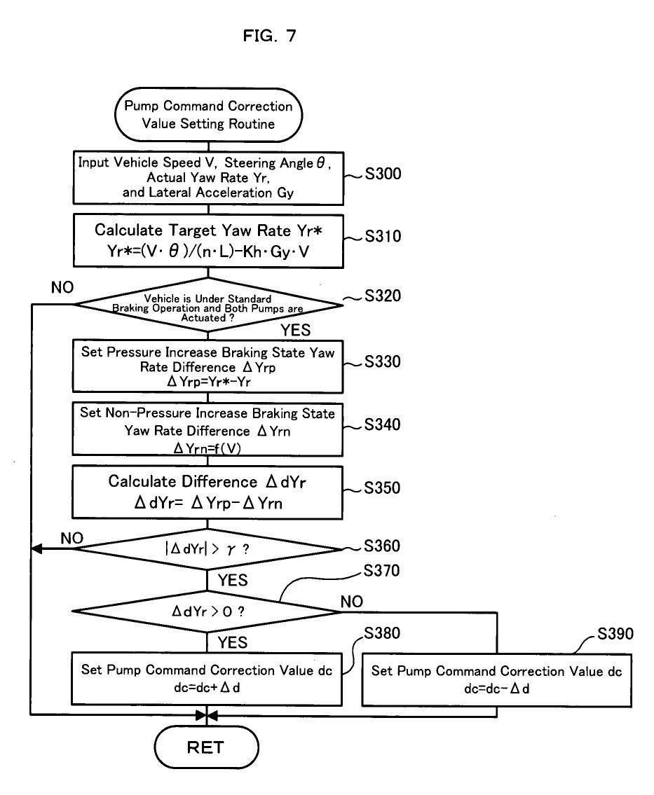

The following describes the details of a pump command correction value setting routine that is executed to set the pump command correction value dc, which is used to set the command values d1 and d2 for the pump 115 of the first system 110 and the pump 125 of the second system 120. FIG. 7 is a flowchart showing the pump command correction value setting routine. This routine is performed at a predetermined timing by the brake ECU 105 of the embodiment during braking control of the hybrid vehicle 20.

At the execution timing of the pump command correction value setting routine, the CPU (not shown) of the brake ECU 105 first inputs data required for control, that is, the vehicle speed V, the steering angle θ, the actual yaw rate Yr, and the lateral acceleration Gy (step S300). A target yaw rate Yr* of the hybrid vehicle 20 is calculated from the input data, a gear ratio n of the steering mechanism, a wheel base L, and a previously-adjusted stability factor Kh according to Equation (1) given below (step S310):
Yr*=(V·θ)/(n·L)−Kh·Gy·V (1)
In the hybrid vehicle 20 of the embodiment, the target yaw rate Yr* and the actual yaw rate Yr have positive values counterclockwise about the center of gravity of the vehicle. The CPU subsequently refers to the settings of predetermined flags and determines whether the hybrid vehicle 20 is under standard braking operation and whether both the pump 115 of the first system 110 and the pump 125 of the second system 120 in the brake actuator 102 are actuated to be operated (step S320). The terminology ‘standard braking operation’ means braking operation without control of the holding solenoid valves 112a, 112d, 122b, and 122c or control of the pressure reduction solenoid valves 113a, 113d, 123b, and 123c of the brake actuator 102, that is, braking operation without ABS (antilock brake system) control, TRC (traction control), or VSC (vehicle system control). When the hybrid vehicle 20 is not under standard braking operation or when both the pump 115 of the first system 110 and the pump 125 of the second system 120 in the brake actuator 102 are not actuated to be operated, a negative answer is given at step S320. In this case, the CPU skips a subsequent series of processing and immediately exits from this pump command correction value setting routine of FIG. 7.

When the hybrid vehicle 20 is under standard braking operation and when both the pump 115 of the first system 110 and the pump 125 of the second system 120 in the brake actuator 102 are actuated to be operated, an affirmative answer is given at step S320. In this case, the processing of steps S100 to S210 in the braking control routine of FIG. 3 is performed without ABS control, TRC, or VSC. This state is hereafter referred to as the ‘pressure increase braking state’. In this pressure increase braking state, the result of subtraction of the actual yaw rate Yr input at step S300 from the target yaw rate Yr* calculated at step S310 is set to a pressure increase braking state yaw rate difference ΔYrp (step S330). In another possible state, the hybrid vehicle 20 is under standard braking operation, but neither the pump 115 of the first system 110 nor the pump 125 of the second system 120 in the brake actuator 102 is actuated to be operated. This state is hereafter referred to as the ‘non-pressure increase braking state’. A non-pressure increase braking state yaw rate difference ΔYrn, which is a difference (Yr*−Yr) between the target yaw rate Yr* and the actual yaw rate Yr in the non-pressure increase braking state, is subsequently set based on the vehicle speed V input at step S100 (step S340). In this embodiment, a variation in non-pressure increase braking state yaw rate difference ΔYrn against the vehicle speed V is stored as a non-pressure increase braking state yaw rate difference setting map in an EEPROM (not shown) of the brake ECU 105. The non-pressure increase braking state yaw rate difference ΔYrn is read corresponding to the given vehicle speed V from this non-pressure increase braking state yaw rate difference setting map. The non-pressure increase braking state yaw rate difference setting map has been specified in advance experimentally and analytically and is occasionally updated according to a non-pressure increase braking state yaw rate difference learning routine (not shown). The non-pressure increase braking state yaw rate difference learning routine is executed at a predetermined timing to calculate the difference between the target yaw rate Yr* and the actual yaw rate Yr under standard braking operation without actuation of the pumps 115 and 125 (non-pressure increase braking state). A difference ΔdYr is calculated by subtracting the non-pressure increase braking state yaw rate difference ΔYrn set at step S340 from the pressure increase braking state yaw rate difference ΔYrp set at step S330 (step S350). The CPU identifies whether the calculated difference ΔdYr is out of a preset dead zone (in a range of not less than a value −γ and not greater than a value γ) (step S360). When the calculated difference ΔdYr is within the preset dead zone (step S360: no), the CPU skips a subsequent series of processing and exits from the pump command correction value setting routine of FIG. 7.

When the calculated difference ΔdYr has a relatively large absolute value and is out of the preset dead zone (step S360: yes), there is a variation in pressure increase between the pump 115 of the first system 110 and the pump 125 of the second system 120 in the brake actuator 102, for example, due to the individual variability or the surrounding temperature. In the presence of a variation in pressure increase between the pumps 115 and 125, there is a potential difference in braking force between the first system 110 and the second system 120 in the brake actuator 102 (especially between the right front wheel 65a and the left front wheel 65b in the hybrid vehicle 20 of the embodiment) in the pressure increase braking state (especially immediately after start of actuation of the pumps 115 and 125). The braking force difference between the first system 110 and the second system 120 causes different behaviors of the hybrid vehicle 20 in the pressure increase braking state and in the non-pressure increase braking state. The deviation of the actual yaw rate Yr from the target yaw rate Yr* in the pressure increase braking state is greater than the deviation in the non-pressure increase braking state. By taking into account this potential behavior difference, in response to the affirmative answer at step S360, the CPU determines whether the calculated difference ΔdYr is positive (step S370). When the calculated difference ΔdYr is positive, the pressure increase by the pumps 115 and 125 applies a clockwise yaw moment to the hybrid vehicle 20. In the case of the positive difference ΔdYr (step S370: yes), in order to cancel out the clockwise yaw moment applied by the pressure increase by the pumps 115 and 125, the sum of a previous pump command correction value dc and a restriction value Δd is set to a current pump command correction value dc (step S380). This setting decreases the command value for the pump 115 of the first system 110 corresponding to the right front wheel 65a, while increasing the command value for the pump 125 of the second system 120 corresponding to the left front wheel 65b. After the setting, the CPU terminates the pump command correction value setting routine of FIG. 7. When the calculated difference ΔdYr is negative, on the other hand, the pressure increase by the pumps 115 and 125 applies a counterclockwise yaw moment to the hybrid vehicle 20. In the case of the negative difference ΔdYr (step S370: no), in order to cancel out the counterclockwise yaw moment applied by the pressure increase by the pumps 115 and 125, the result of subtraction of the restriction value Δd from the previous pump command correction value dc is set to the current pump command correction value dc (step S390). This setting increases the command value for the pump 115 of the first system 110 corresponding to the right front wheel 65a, while decreasing the command value for the pump 125 of the second system 120 corresponding to the left front wheel 65b. After the setting, the CPU terminates the pump command correction value setting routine of FIG. 7. The pump command correction value dc set in this manner is used for correction of the basic pump command value dpB for the pumps 115 and 125 at step S200 in the braking control routine of FIG. 3 as described previously. In this embodiment, the pump command correction value dc has an initial value of 0, and the restriction value Δd is set to a relatively small value for gradual variation of the pump command correction value dc.

In the hybrid vehicle 20 of the embodiment described above, in response to the driver's depression of the brake pedal 85, the braking force demand BF* required by the driver may be satisfied based on both the master cylinder pressure Pmc and the pressure increase by the pumps 115 and 125. In this case, the brake actuator 102 of the HBS 100 is controlled (steps S170 to S200 in the braking control routine of FIG. 3) to satisfy the braking force demand BF* with correction of the pressure increase by the pumps 115 and 125 (step S190) based on the behavior of the hybrid vehicle 20 in the braking state. In the presence of a variation in pressure increase between the pumps 115 and 125 due to, for example, the individual variability, the hybrid vehicle 20 has different behaviors in the non-pressure increase braking state that is under standard braking operation without actuation of the pumps 115 and 125 and in the pressure increase braking state that is under standard braking operation with actuation of the pumps 115 and 125. By taking into account this behavior difference, the pump command correction value setting routine of FIG. 7 is executed to set the pump command correction value dc for correction of the basic pump command value dpB for the pumps 115 and 125, based on the difference ΔdYr between the non-pressure increase braking state yaw rate difference ΔYrn and the pressure increase braking state yaw rate difference ΔYrp. In the braking control routine of FIG. 3, the pump command correction value dc set by the pump command correction value setting routine of FIG. 7 is used to correct the basic pump command value dpB, which is based on the compensated braking force BFpp. The compensated braking force BFpp is determined according to the braking force demand BF*, the regenerative braking force BFr, and the operational braking force BFpmc. In this manner, the braking control of the embodiment performs correction of the pressure increase by the pumps 115 and 125 based on the behavior of the hybrid vehicle 20 in the braking state, that is, correction of the basic pump command value dpB with the pump command correction value dc based on the difference ΔdYr. Even in the presence of a variation in pressure increase between the pump 115 of the first system 110 and the pump 125 of the second system 120 due to, for example, the individual variability, such correction desirably reduces a potential difference in braking force between the first system 110 and the second system 120 (that is, between the right front wheel 65a and the left front wheel 65b), which is caused by the variation in pressure increase. The braking control of the embodiment thus desirably stabilizes the behavior of the hybrid vehicle 20 in the braking state, while effectively preventing the driver from feeling uncomfortable in the braking state. The use of both the target yaw rate Yr* and the actual yaw rate Yr detected by the yaw rate sensor 88 ensure accurate detection of the behaviors of the hybrid vehicle 20 in the non-pressure increase braking state and in the pressure increase braking state. The accurate detection of the behaviors more effectively reduces a potential difference in braking force between the first system 110 and the second system 120 in the brake actuator 102, which is caused by the variation in pressure increase between the pumps 115 and 125.

In the event of no generation of the negative pressure Pn at stop of the engine 22 or in the event of a decrease in negative pressure Pn by any reason, the insufficient negative pressure Pn may lead to dissatisfaction of the braking force demand BF* by the sum of the regenerative braking force BFr of the motor 50 and the master cylinder pressure Pmc-based operational braking force BFpmc. In such cases, the compensated braking force BFpp based on the pressure increase by the pumps 115 and 125 is utilized to satisfy the braking force demand BF*. Even when the driver's pedal force Fpd in the state of decreased negative pressure is equivalent to the pedal force Fpd in the state of non-decreased negative pressure, such braking control ensures satisfaction of the braking force demand BF* required by the driver. The hybrid vehicle 20 of the embodiment thus ensures continuous satisfaction of the driver's braking force demand BF*, while effectively preventing the driver from feeling uncomfortable at the time of the driver's braking operation in the state of decreased negative pressure. In the hybrid vehicle 20 of the embodiment, the hybrid ECU 70 sets the regenerative braking force BFr that is to be produced by regeneration of the motor 50, based on the rotation speed Nm of the motor 50 and the charge level or the state of charge SOC of the high-voltage battery 55. The motor 50 then performs regenerative control in response to the driver's depression of the brake pedal 85 to produce an adequate level of regenerative braking force. This arrangement desirably saves the power consumption of the motors for actuating the pumps 115 and 125. The regeneration of the motor 50 may be restricted according to the state of charge SOC of the high-voltage battery 55. Even when the regenerative braking force BFr produced by regeneration of the motor 50 decreases according to the state of charge SOC of the high-voltage battery 55, the braking control of the embodiment utilizes the compensated braking force BFpp based on the pressure increase by the pumps 115 and 125 to satisfy the braking force demand BF* required by the driver.

The brake actuator 102 included in the HBS 100 of the embodiment has the first system 110 and the second system 120 of the cross arrangement. The brake actuator 102 is not restricted to such a cross arrangement but may be structured to enable independent application of the braking force to at least one pair of left and right wheels. The braking control of the invention effectively reduces a potential difference in braking force that may arise between one pair of left and right wheels due to a variation in pressure increase between pumps of multiple braking systems included in a brake actuator. The brake actuator 102 included in the HBS 100 of the embodiment may have a pressure accumulator or pressure reservoir. The technique of the invention is also applicable to a braking mechanism equipped with a brake actuator having two braking systems of a front-rear arrangement, as well as to a braking mechanism equipped with a brake actuator having three or more braking systems.

In the hybrid vehicle 20 of the embodiment, the power of the engine 22 is transmitted to the front wheels 65a and 65b via the output shaft 42 or the driveshaft. The power of the engine 22 may alternatively be transmitted to the rear wheels 65c and 65d via the rear axle 66. The power of the engine 22 may be connected to a generator, instead of transmission to the front wheels 65a and 65b or to the rear wheels 65c and 65d. In this modified structure, the motor 50 may be driven with electric power generated by the generator or with electric power generated by the generator and accumulated in a battery. Namely the technique of the invention is also applicable to series hybrid vehicles. In the hybrid vehicle 20 of the embodiment, the power of the motor 50 is transmitted to the rear wheels 65c and 65d via the rear axle 66. The power of the motor 50 may alternatively be transmitted to the front wheels 65a and 65b. The belt-driven CVT 40 may be replaced by a toroidal CVT or a step transmission.

The embodiment discussed above is to be considered in all aspects as illustrative and not restrictive. There may be many modifications, changes, and alterations without departing from the scope or spirit of the main characteristics of the present invention.

The disclosure of Japanese Patent Application No. 2006-132863 filed May 11, 2006 including specification, drawings and claims is incorporated herein by reference in its entirety.

What is claimed is:

1. A vehicle having multiple wheels, the vehicle comprising:
a fluid pressure braking structure including multiple braking systems respectively having a pressurization unit for pressurization of an operation fluid and respectively related to specific wheels selected among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units;
a behavior detection module that detects a behavior of the vehicle in a braking state; and
a braking control module that controls the fluid pressure braking structure to satisfy a braking force demand required by the driver with correction of the pressure increase by the pressurization unit based on the detected behavior of the vehicle in the case of generation of a braking force in response to the driver's braking operation by utilizing the operational pressure and the pressure increase by the pressurization units of the multiple braking systems.

2. The vehicle in accordance with claim 1, the vehicle further comprising:
a braking force demand setting module that sets the braking force demand required by the driver in response to the driver's braking operation;
a pressure increase command value setting module that sets a pressure increase command value for each pressurization unit included in each of the multiple braking systems based on the set braking force demand; and
a correction module that sets a correction value for the pressure increase command value of each pressurization unit based on both a behavior of the vehicle detected in a non-pressure increase braking state without actuation of any pressurization unit and a behavior of the vehicle detected in a pressure increase braking state with actuation of the respective pressurization units,
wherein the braking control module controls the fluid pressure braking structure to satisfy the braking force demand in response to the driver's braking operation with actuation of each pressurization unit based on the set pressure increase command value and the set correction value.

3. The vehicle in accordance with claim 2, wherein the behavior detection module includes an actual yaw rate detection unit that detects an actual yaw rate of the vehicle.

4. The vehicle in accordance with claim 3, the vehicle further comprising:
a target yaw rate setting module that sets a target yaw rate of the vehicle; and
a yaw rate deviation obtainment module that obtains a yaw rate deviation as a difference between the detected actual yaw rate and the set target yaw rate,
wherein the correction module sets the correction value for the pressure increase command value of each pressurization unit based on a difference between a yaw rate deviation in the pressure increase braking state and a yaw rate deviation in the non-pressure increase braking state.

5. The vehicle in accordance with claim 1, wherein the fluid pressure braking structure utilizes the multiple braking systems to individually apply a braking force to at least one pair of left and right wheels.

6. The vehicle in accordance with claim 2, the vehicle further comprising:
a motor capable of producing at least a regenerative braking force; and
an accumulator unit that transmits electric power to and from the motor,
wherein the pressure increase command value setting module sets the pressure increase command value of each pressurization unit based on the set braking force demand, the regenerative braking force produced by the motor, and an operational braking force based on the operational pressure of the operation fluid.

7. The vehicle in accordance with claim 6, the vehicle further comprising:
an internal combustion engine capable of outputting power to a pair of left and right first wheels,
wherein the motor is capable of inputting and outputting power from and to a pair of left and right second wheels different from the pair of left and right first wheels, and wherein the fluid pressure braking structure includes two braking systems of a cross arrangement as the multiple braking systems.

8. A control method of a vehicle, the vehicle including: multiple wheels; and a fluid pressure braking structure including multiple braking systems respectively having a pressurization unit for pressurization of an operation fluid and respectively related to specific wheels selected among the multiple wheels, the fluid pressure braking structure capable of making the multiple braking systems output a braking force by utilizing an operational pressure of the operation fluid produced by a driver's braking operation and a pressure increase induced by pressurization of the operation fluid by the respective pressurization units, the control method comprising the steps of:
controlling the fluid pressure braking structure to satisfy a braking force demand required by the driver with correction of the pressure increase by the pressurization unit based on a behavior of the vehicle detected in a braking state in the case of generation of a braking force in response to the driver's braking operation by utilizing the operational pressure and the pressure increase by the pressurization units of the multiple braking systems.

9. The control method of the vehicle in accordance with claim 8, the control method further comprising:
setting the braking force demand required by the driver in response to the driver's braking operation;
setting a pressure increase command value for each pressurization unit included in each of the multiple braking systems based on the set braking force demand; and
setting a correction value for the pressure increase command value of each pressurization unit based on both a behavior of the vehicle detected in a non-pressure increase braking state without actuation of any pressurization unit and a behavior of the vehicle detected in a pressure increase braking state with actuation of the respective pressurization units,
wherein the controlling step controlling the fluid pressure braking structure to satisfy the braking force demand in response to the driver's braking operation with actuation of each pressurization unit based on the set pressure increase command value and the set correction value.

10. The control method of the vehicle in accordance with claim 9, wherein the vehicle further includes an actual yaw rate detection unit that detects an actual yaw rate of the vehicle as the behavior of the vehicle.

11. The control method of the vehicle in accordance with claim 10, the control method further comprising:
setting a target yaw rate of the vehicle; and
obtaining a yaw rate deviation as a difference between the detected actual yaw rate and the set target yaw rate,
wherein the step of setting a correction value setting the correction value for the pressure increase command value of each pressurization unit based on a difference between a yaw rate deviation in the pressure increase braking state and a yaw rate deviation in the non-pressure increase braking state.

12. The control method of the vehicle in accordance with claim 8, wherein the fluid pressure braking structure utilizes the multiple braking systems to individually apply a braking force to at least one pair of left and right wheels.

13. The control method of the vehicle in accordance with claim 9, wherein the vehicle further includes: a motor capable of producing at least a regenerative braking force; and an accumulator unit that transmits electric power to and from the motor,
wherein the step of setting a pressure increase command value setting the pressure increase command value of each pressurization unit based on the set braking force demand, the regenerative braking force produced by the motor, and an operational braking force based on the operational pressure of the operation fluid.

14. The control method of the vehicle in accordance with claim 13, wherein the vehicle further includes an internal combustion engine capable of outputting power to a pair of left and right first wheels, wherein the motor is capable of inputting and outputting power from and to a pair of left and right second wheels different from the pair of left and right first wheels, and wherein the fluid pressure braking structure includes two braking systems of a cross arrangement as the multiple braking systems.
